(19) United States
(12) Patent Application Publication
(10) Pub. No.: US 2005/0069687 A1
(43) Pub. Date: Mar. 31, 2005

(54) Apparatus and method for making a tensile diaphragm with a compressive region

(76) Inventor: Phillip W. Barth, Portola Valley, CA (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/670,554

(22) Filed: Sep. 25, 2003

(51) Int. Cl. B32B 7/02

(52) U.S. Cl. 428/216; 428/212

(57) ABSTRACT

An apparatus and method for making a composite tensile diaphragm having a nanopore. The apparatus provides a tensile layer in contact with a compressive layer. A small region of the tensile layer is removed to expose a small portion of the compressive layer. The compressive region of the tensile layer is small enough to avoid the buckling or wrinkling of the material. The apparatus has a length to thickness ratio from 10 to 60. Also disclosed is a method of making the apparatus.

### TECHNICAL FIELD

The invention relates generally to the field of nanopores and more particularly to an apparatus and method for making a tensile diaphragm with a compressive region.

### BACKGROUND

Manipulating matter at the nanometer scale is important for many electronic, chemical and biological advances (See Li et al., “Ion beam sculpting at nanometer length scales”, Nature, 412: 166-169, 2001). These pores have also been effective in localizing molecular-scale electrical junctions and switches (See Li et al., “Ion beam sculpting at nanometer length scales”, Nature, 412: 166-169, 2001).

Artificial nanopores have been fabricated by a variety of research groups with a number of materials. Generally, the approach is to fabricate these nanopores in a solid-state material or a thin freestanding diaphragm of material supported on a frame of thick silicon. Some materials that have been used to date include silicon nitride and silicon dioxide. The silicon nitride diaphragms can be expected to exhibit high burst pressures due to high yield strength of the silicon nitride material and due to moderate-to-high tensile stresses built into the diaphragm material that keeps the diaphragm uniformly flat. In contrast, the silicon dioxide diaphragms can be expected to be buckled and wrinkled due to compressive stresses in a diaphragm (See e.g., Petersen, K. E., Guamieri, C. R., Young's Modulus measurements of thin films using micromechanics, J. Appl. Phys., Vol. 50, No. 11, pp. 6761-6766, 1979). The buckling and wrinkling produces high local stresses, and so the silicon dioxide can be expected to exhibit low burst pressures. In practice, these types of diaphragms have shown a high failure rate. Nevertheless, it is desirable to investigate the properties of nanopores fabricated in silicon dioxide and other compressive materials. It is, therefore, desirable to have a diaphragm having compressive material that is capable of being used for nanopore fabrication and that does not suffer from the problem of buckling before or after fabrication. It is also desirable to provide a diaphragm having compressive material that exhibits high burst pressures and does not wrinkle. In addition, it is desirable to provide a method for making these structures at the nanometer scale. These and other problems with the prior art processes and designs are obviated by the present invention. The references cited in this application infra and supra, are hereby incorporated in this application by reference. However, cited references or art are not admitted to be prior art to this application.

### SUMMARY OF THE INVENTION

The invention provides an apparatus and method for nanopore construction. The apparatus comprises a tensile diaphragm supported by a rigid frame, the diaphragm having an overall tensile characteristic and having a compressive region situated within the diaphragm, such that the lateral extent of the compressive region is small enough to avoid buckling or wrinkling of the compressive region. The tensile diaphragm may comprise layers of silicon nitride material and silicon dioxide material. The compressive region may comprise a silicon dioxide material. The tensile diaphragm has a length to thickness ratio from about 4 to about 1000.

The invention also provides a method of making the apparatus. The method of making the apparatus comprises providing a composite diaphragm with a net tensile characteristic, supported by a rigid frame, and removing a region from the composite diaphragm to leave a compressive region. A nanopore may subsequently be fabricated in the compressive region.

### BRIEF DESCRIPTION OF THE FIGURES

The invention is described in detail below with reference to the following figures:

FIG. 1 shows a schematic representation of the present invention.

FIG. 2 shows an enlarged cross-sectional view of the present invention.

FIG. 3A shows a step of the method of the present invention.

FIG. 3B shows a step of the method of the present invention.

FIG. 3C shows a step of the method of the present invention.

FIG. 3D shows a step of the method of the present invention.

FIG. 3E shows a nanopore fabricated in the compressive region of the diaphragm present invention.

FIG. 3F shows the final structure of a nanopore fabricated in the compressive region of the diaphragm present invention.

### DETAILED DESCRIPTION OF THE INVENTION

Before describing the present invention in detail, it is to be understood that this invention is not limited to specific compositions, method steps, or equipment, as such may vary. It is also to be understood that the terminology used herein is for the purpose of describing particular embodiments only, and is not intended to be limiting. Methods recited herein may be carried out in any order of the recited events that is logically possible, as well as the recited order of events.

Unless defined otherwise below, all technical and scientific terms used herein have the same meaning as commonly understood by one of ordinary skill in the art to which this invention belongs. Still, certain elements are defined herein for the sake of clarity. In the event that terms in this application are in conflict with the usage of ordinary skill in the art, the usage herein shall be controlling.

Where a range of values is provided, it is understood that each intervening value, to the tenth of the unit of the lower limit unless the context clearly dictates otherwise, between the upper and lower limit of that range, and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits; ranges excluding either or both of those included limits are also included in the invention.

Methods recited herein may be carried out in any order of the recited events that is logically possible, as well as the recited order of events.

It must be noted that, as used in this specification and the appended claims, the singular forms “a”, “an” and “the” include plural referents unless the context clearly dictates otherwise.

The term “about” refers to being closely or approximate to, but not exactly. A small margin of error is present. This margin of error would not exceed plus or minus the same integer value. For instance, about 0.1 micrometers would mean no lower than 0 but no higher than 0.2.

The term “nanopore” refers to any pore or hole between at least a pair of electrodes or a hole in a solid substrate. Nanopores can range in size and can range from about 1 nm to about 300 nm. Most effective nanopores have been roughly around 2 nm.

The term “adjacent ” refers to anything that is near, next to or adjoining. For instance, a tensile layer may be near a compressive layer, next to a compressive layer or adjoining a compressive layer.

The term “substantially flat” refers to material that is nearly flat or planar in design. The material or layer may be under tension and contain one or more small wrinkles. The material in most cases would show absence of substantial wrinkles or buckling. In most cases, this term should be interpreted to be nearly or approximately uniformly flat. There are limited or no uneven surfaces.

The term “lateral extent” refers to a direction or directions lying substantially parallel to the substantially flat major surfaces of a component of a diaphragm, diaphragm component, or entire device. Thus, for example, a long thin finger of material meandering along a surface has a lateral extent that is small in relation to its overall length in a direction perpendicular to that length, and a lateral extent that is long in the direction of its length. Again, for example, an area of circular shape has a lateral extent that is uniform in all directions parallel to the major surface in which it lies.

The term “tensile diaphragm” refers to a diaphragm which has one of a purely tensile local strain energy and a local strain energy which has both tensile and compressive components which, when integrated through the thickness of the diaphragm in a small area of the diaphragm, evaluates to a local net strain energy which is tensile. The term “tensile diaphragm” also refers to a diaphragm that has a net tensile strain energy when the local strain energy is integrated over the entire surface area of the diaphragm, including any areas which may have a purely compressive strain energy.

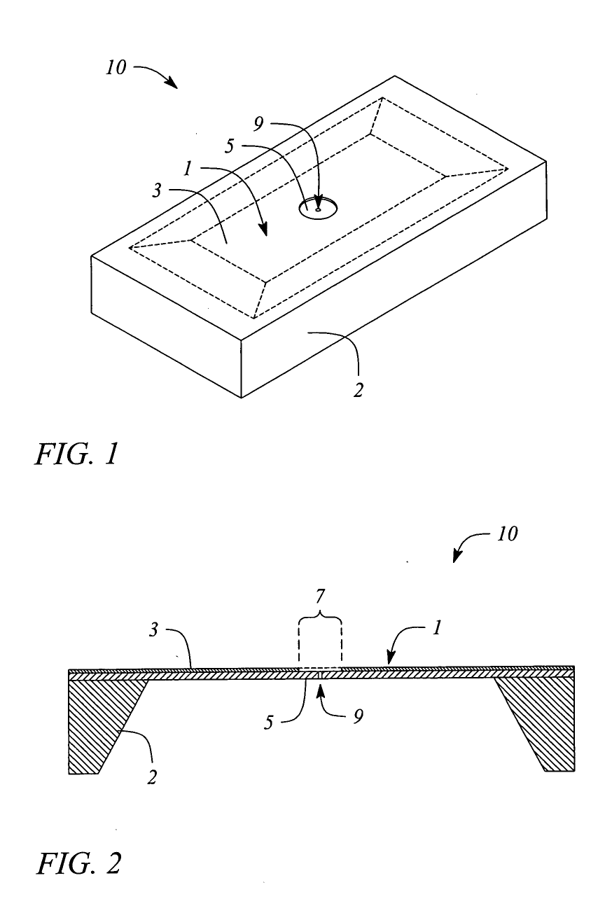

FIGS. 1-2 show the apparatus of the present invention. A silicon chip 10 supporting a tensile diaphragm 1 is generally illustrated in the figures. The tensile diaphragm may range in size from 5 to at least 100 micrometers. The tensile diaphragm 1 may comprise a tensile layer 3 and a compressive layer 5 contacting the tensile layer 3. The tensile diaphragm 1 may be designed from different materials or a single material. The tensile diaphragm 1 is designed in such a way that buckling or wrinkling of the compressive layer 5 and tensile layer 3 will be avoided by choosing the thickness and strain level in compressive layer 5, and the thickness and strain level in compressive layer 5, such that the total tensile strain energy in layer 3 is greater than the total compressive strain energy in layer 5. The dimensions described here are for illustrative purposes only and should not be interpreted to limit the scope of invention. More important to the invention is the ability of the invention to minimize the ratio of the lateral extent to the thickness of the compressive region 7. The ratio of lateral extent to thickness can range from about 10 to 60. This prevents the compressive layer 5 from wrinkling or buckling.

Having described the apparatus of the invention, a description of the method is now in order.

In general, the method of making the invention comprises providing a tensile diaphragm supported by a rigid frame and removing a tensile region on the tensile diaphragm to leave a local compressive region.

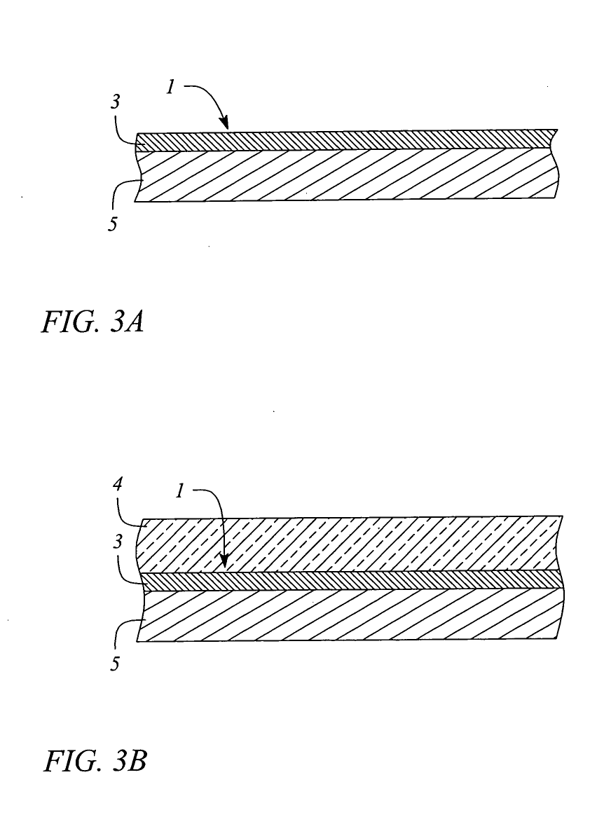

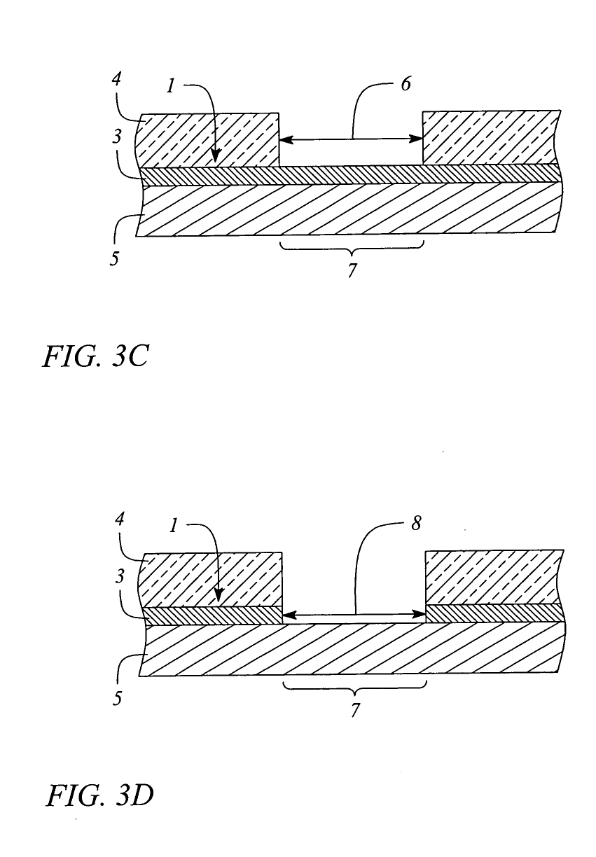

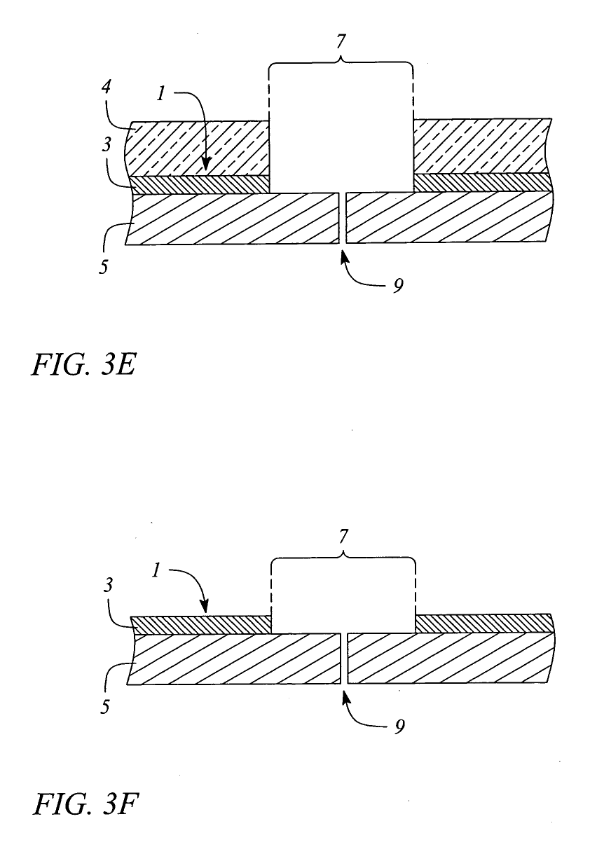

Referring now to FIGS. 3A-3F, FIG. 3A shows a cross sectional view of a tensile diaphragm 1 which may be made or produced by techniques well known in the art, such as for example by depositing layers on one surface of a silicon wafer and etching an opposing surface of the silicon wafer to remove a selected region of silicon and leave a tensile diaphragm supported by a silicon frame 2 as depicted in FIGS. 1 and 2. It is well known that if such silicon etching is carried out, for example, in an aqueous solution of tetramethyl ammonium hydroxide, neither silicon nitride nor silicon dioxide are appreciably etched while the silicon is removed. The tensile diaphragm 1 may comprise a composite material comprising a tensile layer 3 and a compressive layer 5. Materials such as silicon dioxide and silicon nitride may be employed. These materials are commonly used in silicon wafers and other semiconductor materials.

FIG. 3B shows a layer 4 of photoresist deposited on the top surface of tensile diaphragm 1. FIG. 3C shows the use of photolithography or a similar technique to remove a region 6 from the photoresist layer 4 on top of the composite tensile diaphragm 1. The removed region 6 may vary in shape and lateral extent, but is likely to be a circular region around 5 micrometers in diameter.

FIG. 3D shows the next step of the method of the present invention. Plasma etching is used to etch through the silicon nitride layer, removing region 8 over the compressive region 7 until the silicon dioxide layer is reached. It is well known in the art that there are techniques available which maximize the etch rate of silicon nitride in relation to silicon dioxide during plasma etching. See, for example, the description of a 40:1 etch rate selectivity of silicon nitride to silicon dioxide in “High-Selectivity Silicon Nitride Etch Process,” by Ying Wang, et. al., Semiconductor International, Jul. 1, 1998, available on the internet at http://www.reed electronics.com/semiconductor/index.asp?layout=article&articleid=CA163999&rid=0&r me=0&cfd=1. Thus, for a typical silicon nitride layer thickness of 200 nm, and a typical silicon dioxide layer thickness of 500 nm, it is possible to completely remove a region of the silicon nitride layer while minimally etching either the upper surface of the silicon dioxide layer or the exposed lower surface of the silicon nitride layer. Optionally, the exposed lower surface of the silicon dioxide layer may be protected by a deposited region, not shown, of a material such as photoresist, but such protection is not necessary in most cases.

At this point the structure and method of the present invention are completed and nanopore fabrication may proceed. FIG. 3E shows by way of example how a nanopore 9 is fabricated by using a focused ion beam to drill a hole through the silicon dioxide layer 5 in compressive region 7 with a diameter on the order of 50-100 nm, followed by sculpting in a low energy ion beam to reduce the diameter of a portion of the hole to dimensions on the order 1-50 nm, forming nanopore 9. FIG. 3F show the final step in creating the nanopore. After the nanopore 9 has been fabricated the photoresist layer 4 is removed in a solvent. FIG. 2 shows on a larger scale how the final tensile diaphragm looks after removal of the photoresist layer.

Optionally, it is possible to vary the order of the steps near the end of the fabrication process so that the photoresist layer 4 is removed before focused ion beam drilling, or before sculpting of the nanopore in the low energy ion beam; these optional variations are not explicitly illustrated.

It will be appreciated that the fabrication sequence described above is by way of example only, and that there are others techniques well known to those skilled in the art which may be used to arrive at the same final structure. For example, silicon nitride may be etched in hot phosphoric acid instead of in a plasma etch system, and various dry etching techniques may be employed instead of plasma etching. Shadow masking may be used instead of photolithography, and metal layers may be used instead of photoresist as etch-resistant layers.

It will be appreciated that the fabrication of a nanopore in a compressive region may be accomplished by means other that focused ion beam drilling and argon ion beam sculpting. For example, other known means of fabricating a nanopore include masking with a nanoparticle followed by layer evaporation around the masking nanoparticle, next followed by removal of the nanoparticle and etching within the hole that had been masked by the nanoparticle. Such techniques, both known and unknown may be used to fabricate nanopores within the compressive region 7 of the present invention.

It will be appreciated that, while the present invention is aimed toward utility in fabrication of nanopore structures, it may prove to have utility for fabrication of other devices both known and unknown. Such devices include devices with microscale and nanoscale dimensions. Microscale dimensions are defined to include dimensions from 100 nm to 1 mm, and nanoscale dimensions are defined to include dimension from 0.1 nm to 1 um.

It will be appreciated that the description provided above has been for a case where the tensile diaphragm completely surrounds the lateral extent of the compressive region 7. However, such complete surrounding is not a necessity of the present invention, and the lateral extent of the compressive region 7 may extend, in a sufficiently narrow fashion that buckling is avoided, to be coincident in one or more lateral directions with the lateral extent of the composite diaphragm 1. Accordingly, and in addition, narrow fingers of compressive region 7 may extend in multiple fashions within the lateral area of composite diaphragm 1 without producing buckling of either compressive region 7 or composite diaphragm 1. Additionally, multiple instances of compressive region 7 may be present within the area of composite diaphragm 1.

1. A structure for the construction of one of a microscale and nanoscale device, comprising:
a rigid frame supporting a tensile diaphragm, the diaphragm having
a first region comprising material having a net compressive strain energy, said region having a first thickness and a first lateral extent, and
a second region laterally adjacent to the first region, the second region comprising material having a net tensile strain energy,
wherein the net strain energies of the first region plus the second region are tensile, and
wherein the first lateral extent of the first region in relation to the first thickness is sufficiently small to avoid buckling or wrinkling of the first region.

2. A structure as recited in claim 1, wherein the nanoscale device is a nanopore.

3. A structure as recited in claim 1, wherein the first region comprises a layer of silicon dioxide.

4. A structure as recited in claim 1, wherein the second region comprises a composite set of layers.

5. A structure as recited in claim 4, wherein one of the composite set of layers comprises a layer of silicon nitride.

6. A structure as recited in claim 5, wherein the silicon nitride layer is from 50 nm to 500 nm in thickness.

7. A structure as recited in claim 5, wherein the silicon nitride layer is about 200 nm thick.

8. A structure as recited in claim 4, wherein one of the composite set of layers comprises a layer of silicon dioxide.

9. A structure as recited in claim 8, wherein the silicon dioxide layer is from 50 to 600 nm in thickness.

10. A structure as recited in claim 1, wherein the first region is from 50 to 600 nm in thickness.

11. A structure as recited in claim 1, wherein the first region is about 500 nm thick.

12. A structure as recited in claim 1, wherein the tensile diaphragm has a width to thickness ratio from about 4 to about 1000.

13. A structure as recited in claim 1, wherein the width of the tensile diaphragm is about 40 micrometers.

14. A structure as recited in claim 1, wherein the first region has a width to thickness ratio from about 4 to about 60.

15. A structure as recited in claim 1, wherein the first region has a width of about 5 micrometers.

16. A method of making a composite tensile diaphragm, comprising:
(a) providing a rigid frame supporting a composite tensile diaphragm comprising a tensile layer and a compressive layer;
(b) defining a region to be etched in the tensile layer; and
(c) etching a region in the tensile layer to expose the compressive layer.

17. A method as recited in claim 10, wherein the tensile layer comprises silicon nitride.

18. A method as recited in claim 10, wherein the compressive layer comprises silicon dioxide.

19. A method as recited in claim 10, wherein photolithography is used to define the region to be etched.

20. A method as recited in claim 10, wherein plasma etching is used to etch the region in the tensile layer.
